(19) United States
(12) Patent Application Publication
(10) Pub. No.: US 2007/0150256 A1
(43) Pub. Date: Jun. 28, 2007

(54) Auto translator and the method thereof and the recording medium to program it

(76) Inventor: In-Seop Lee, Seoul (KR)

Correspondence Address: IPLA P.A., 3580 WILSHIRE BLVD., 17TH FLOOR, LOS ANGELES, CA, 90010, US

(21) Appl. No.: 10/597,016

(22) PCT Filed: Jan. 3, 2005
(86) PCT No.: PCT/KR05/00065

§ 371 Date: Jul. 6, 2006

(30) Foreign Application Priority Data
Jan. 6, 2004 (KR) 10-2004-0000801

(51) Int. Cl. G06F 17/28

(52) U.S. Cl. 704/2

(57) ABSTRACT

This invention is about the auto translator, the automatic translation method that is used by this auto translator, and the recording medium by which this auto translation method is programmed. This invention makes the translation of sentence (English sentence [symbol] Chinese sentence) more accurate and natural. Because the peculiar properties of Chinese grammar were taken into consideration through the specific algorithms when English is translated into Chinese and Chinese is translated into English. The specific algorithms are the main conception of this invention. The auto translator from this invention consists of: 1) The Word Database (100), 2) The analyzing device (200), 3) The arranging device (300), 4) The device (400)— the modulatory translation module, 5) The device (500)— the specific translation module, 6) The device (600)— the general translation module, 7) The device (700)— It outputs the complete translated Chinese sentence. The Linking Pointer of the specific sentence elements which links with the device (500)— the specific translation module — cooperates with 5 (peculiar) Translation Modules (501-505). Through the process of 1), 2), 3), 4), 5), 6), 7) and the First Specific Translation Module (501)˜ the Fifth Specific Translation Module (505), the translation of sentence (English sentence [symbol] Chinese sentence) be created more accurate and natural. This invention is fully verified by the Demo Program (The specific algorithms were applied) which was developed by the applicant in 2003 3. And All the sample sentences of [Best Mode for Carrying Out the Invention] (FIG. 5, 6, 7, 8, 9) were quoted from the Demo Program.

### TECHNICAL FIELD

This invention is about the auto translator, the automatic translation method that is used by this auto translator, and the recording medium by which this auto translation method is programmed. To explain it in more detail, this invention makes the translation of English sentences [symbol] Chinese sentences more accurate and natural.

Because the unique grammar properties of Chinese language were taken into consideration through the specific algorithms when English is translated into Chinese, or Chinese is translated into English. This invention is fully verified by the Demo Program(The specific algorithms were applied) which was developed by the applicant in 2003 3.

### BACKGROUND ART

Generally speaking, many machine translators that stored dictionaries of each language, grammar of languages in a computer storage device and programmed in order to execute an order that translate one language into another, were developed diversely in recent years.

For one example, patent registered in South Korea in the past, “Machine Translator utilizing Doorframe of which including Protector and Syntax Nod(registered number: 10-0329109)”—Let's call it MTD here—had a following process of translation.

When the user of MFD inputs the original sentence to translate into the target language, then MTD analyzes the original sentence into the morpheme units, and after it determines a part of speech of the words.

Next it searches the words that fixed the meaning of itself just like idioms, compound nouns or compounds, and it reclassifies these words and tags the protector mark to them not to analyze after this process.

And the words that have a significant role of word class in the original sentence just like verb, conjunction, relative, sign are tagged with the protector mark not to analyze after this process. Now MTD analyzes the partial sentence structures between the protectors and checks whether they are noun phrase or prepositional phrase and if they are, it tags them with a proper sentence structure mark.

Next the original doorframes which were composed of the partial sentence structures and protectors, matches the database of original doorframes with the words(verb, conjunction, relative, sign, etc.) which were tagged with the protector mark to choose the doorframes of translation that corresponding each other. The database in the doorframes of translation already had the translated words linking with the original words that were tagged with the protector mark. Now noun phrases and prepositional phrases, which were tagged with the proper sentence structure mark, translate into the words of the target language, and then MTD completes the translation of the original sentence.

The above mentioned, MID machine translator is suitable for English [symbol] Korean translation and is possible for English [symbol] Chinese translation in some grammatical fields where the same syntax patterns exist both English and Chinese language. But MTD has critical problems.

The problems are originated from the fact that Chinese grammar has own some peculiar properties that do not exist in English grammar. Therefore MTD does not have a beneficial effect on English [symbol] Chinese translation. Now let's consider the some peculiar properties of Chinese grammar.

First, Liheci [symbol] —which is one kind of Chinese verbs, disyllabic or trisyllabic verb in Chinese Grammar—is very unique verb. When Liheci exists in the translated Chinese sentence and the original English sentence is the past tense, the Liheci is separated into two parts and between them the letter [symbol] (This Chinese letter means that the sentence is the past tense.) should be located. And at the same time if an adverb of frequency exists in the original English sentence as a sentence element, the corresponding translated Chinese word should be located right after the letter [symbol] . When the original English sentence is not the past tense, the translated Chinese word for the adverb of frequency in English should be located between the two separated Liheci without [symbol] .

MTD machine-translator can not handle this Chinese syntax structure.

Second, Chinese language grammar has a peculiar property when Chinese sentence has the word of the complement of degree as a sentence element. When the word of the complement of degree exists in the translated Chinese sentence, [symbol] (Chinese letter which expresses the degree of the verb in Chinese sentence.) should be located between the translated Chinese verb and the translated Chinese word of the complement of degree.

MTD machine-translator can not handle this Chinese syntax structure. Thirdly, Chinese language grammar has a peculiar property when Chinese sentence has the word of the complement of result as a sentence element. When the word of the complement of result exists in the translated Chinese sentence, that word—the complement of result—should be located just after the translated Chinese verb.

MTD machine translator can not handle this Chinese syntax structure.

Fourthly, Chinese language grammar has a peculiar property when Chinese sentence is the passive voice structure. When the passive voice in English sentence—the sentence structure is “be+p.p.”—translates into Chinese, the translated Chinese sentence also belongs to the passive voice structure. But the passive voice sentence structure in Chinese language splits into two patterns.

One pattern is: If the Chinese verb, which belongs to the passive voice structure, rules over or exercises influence over the action of the animate/things, the Chinese word [symbol] (This word expresses that the sentence is the passive voice in Chinese language.) should be affixed to the head of that Chinese verb. And the other pattern is: If the Chinese verb, which belongs to the passive voice structure, does not rule over or exercise influence over the action of the animate/things, the Chinese word [symbol] should not be affixed to the head of that Chinese verb.

MTD machine translator can not handle this Chinese syntax structure.

Fifthly, Chinese language grammar has a peculiar property when the original English sentence is the adjective phrase sentence.(The form is “be+adjective” in English.) The reason is Chinese language does not use the translated Chinese word for the English word “be” ( [symbol] in Chinese language) in the structure of Chinese adjective phrase sentence. When the adjective phrase sentence in English translates into Chinese, the precisional machine translator should eliminate the translated Chinese word for the original English word “be” and should reconstruct the translated Chinese sentence according to the word order rules in Chinese language.

MTD machine translator can not handle this Chinese syntax structure.

As mentioned above, 5 peculiar properties of Chinese grammar should be taken into consideration in the English [symbol] Chinese machine translation.

### DISCLOSURE OF INVENTION

This invention solved the problems of 5 peculiar properties of Chinese grammar, which existed in the past and present in the field of English [symbol] Chinese machine translation.

To get the solutions that solve 5 problems, as mentioned above, the auto translator from this invention was developed by the applicant.

This auto translator consists of:
(1) The Word Database (100): It has 4 corresponding dictionaries db. Every db is arranged in alphabetical order and recorded the whole information of the English words and the translated Chinese words according to the dictionary editing system in English and Chinese language.
(2) The device (200): It analyzes the words of the inputted original sentence into the morpheme units.
(3) The device (300): It arranges the results of the device (200) for the basic sentence elements that contain a part of speech and this device translates the original English words into Chinese words according to the word dictionary db of the Word Database.
(4) The device (400)—the modulatory translation module: It checks whether the compound word, idiom, colloquialism exist in the results of (300) or not. And if there are, this device modulates the basic sentence elements of them into the modulatory sentence elements and converts a part of speech of them if it needs to do(In this process, new converted word class being created). And this device translates the original English words into Chinese words according to the first, the second, the third word dictionary db.
(5) The device (500)—the specific translation module: It checks the results of (300), the results of (400) and checks the inputted original sentence with the Linking Pointer of the specific sentence elements. And if a linking data exists between then the Linking Pointer of the specific sentence elements checks whether the data of the word(words) is marked with the discerning factor or not. And if it is, the Linking Pointer of the specific sentence elements and the discerning factor indicate that the word(words) should be controlled by the one of 5 (peculiar) specific translation modules. This device (500) has 5 (peculiar) specific translation modules (501˜505) that are activated by the Linking Pointer of the specific sentence elements and the discerning factor jointly. And this device rechecks the results of each specific translation module and rearranges the translated Chinese words and the word order according to the word order rules in Chinese language.
(6) The device (600)—the general translation module: It checks the results of (500) and eliminates the translated Chinese word which is unnecessary in the final translated Chinese sentence and inserts the special Chinese word which is necessary in the final translated Chinese sentence, according to the special translation conditions in Chinese grammar. It rechecks whether the secondly translated Chinese word—which is converted again by the specific translation module (500)—is linked with the word order rules of the Word Database or not. If it is, this device reconstructs the word order of the secondly translated Chinese word according to the word order rules in Chinese language.
(7) The device (700): It outputs the complete translated Chinese sentence.

The Linking Pointer of the specific sentence elements which links with the device (500)—the specific translation module—cooperates with 5 (peculiar) Specific Translation Modules (501˜505).

The First Specific Translation Module (501) checks, by the Linking Pointer of the specific sentence elements and the discerning factor, whether the translated Chinese verb of the original English sentence belongs to Liheci [symbol] —one kind of verbs in Chinese Grammar—or not. And if it belongs to Liheci, this module checks, by the Linking Pointer of the specific sentence elements and the discerning factor, whether the original English sentence is the past tense or not. And the result of checking is the past tense, this module puts [symbol] between the two separated words of the translated Chinese verb. At the same time this module checks whether the original English sentence has an adverb of frequency or not. And if it has, this module puts the translated Chinese word for the adverb of frequency in English just after [symbol] . If the original Wish sentence is not the past tense, the translated Chinese word for the adverb of frequency in English is located without [symbol] .

The Second Specific Translation Module (502) checks the translated Chinese words, by the Lining Pointer of the specific sentence elements and the discerning factor, whether the word—the complement of degree, as a sentence element—exists or not. If it exists, the Linking Pointer of the specific sentence elements and the discerning factor check whether the complement of degree accompanies the translated Chinese verb of the original English sentence or not. If it does, this module inserts the Chinese word [symbol] just behind the translated Chinese verb. And just after the word [symbol] , this module locates the translated Chinese word, the complement of degree.

The Third Specific Translation Module (503) checks the translated Chinese words, by the Linking Pointer of the specific sentence elements and the discerning factor, whether the word—the complement of result, as a sentence element—exists or not. If it exists, the Linking Pointer of the specific sentence elements and the discerning factor check whether the complement of result accompanies the translated Chinese verb of the original English sentence or not. If it does, this module locates the translated Chinese word, the complement of result, just after the translated Chinese verb.

The Fourth Specific Translation Module (504) checks, by the Linking Pointer of the specific sentence elements and the discerning factor, whether the original English sentence structure is “be+p.p” or not. And if it is, this module checks whether the translated Chinese verb of the original English sentence rules over, or exercises influence over the action of the animate/things or not. If it does, the Chinese word [symbol] is affixed to the head of the translated Chinese verb. And this module rechecks the translated Chinese word of the English preposition—which locates just behind the English verb—in relation to the translated Chinese verb according to the Chinese grammar. Because the translated Chinese word of that English preposition has some special translation conditions in Chinese language. And next this module reconstructs the translated Chinese words according to the word order rules in Chinese language.

The Fifth Specific Translation Module (505) checks, by the Linking Pointer of the specific sentence elements and the discerning factor, whether the original English sentence is an adjective phrase sentence or not. If it is, this module eliminates the translated Chinese word for the original English word “be” and next reconstructs the translated Chinese words according to the word order rules in Chinese language.

Every English word, in the Word Database, has the data about the morpheme units (a common feature), the basic sentence elements (a common feature), the modulatory sentence elements (an independent feature), the specific sentence elements (an independent feature). Especially the specific sentence elements are marked with the discerning factor in the first, the second, the third word dictionary db. The discerning factor, checks the information of the specific sentence elements in English words, is activated in the specific translation modules by the Linking Pointer of the specific sentence elements. The discerning factor and the Linking Pointer the of specific sentence elements appoint the English word and the translated Chinese word which has the specific sentence elements to the corresponding first˜fifth specific translation module.

And they help 5 Specific Translation Modules (501˜505) to translate the original English sentence into the accurate and natural translated Chinese sentence.

The First word dictionary db of the Word Database stored the information of the common word. The second, the third word dictionary db of the Word Database stored the information of the compound word, idiom, colloquialism. The fourth word dictionary db stored the information of the terminology.

When the original English sentence translates into Chinese sentence,
1) If the translated Chinese verb—which is selected from the Word Database—belongs to Liheci, the Linking Pointer of the specific sentence elements and the discerning factor check whether the original English sentence is the past tense or not, and check whether the original English sentence has an adverb of frequency or not.
2) If the translated Chinese word is checked as the word of the complement of degree, the Linking Pointer of the specific sentence elements and the discerning factor check whether the word itself accompanies the translated Chinese verb of the original English sentence or not.
3) If the translated Chinese word is checked as the word of the complement of result, the Linking Pointer of the specific sentence elements and the discerning factor check whether the word itself accompanies the translated Chinese verb of the original English sentence or not.
4) If the original English sentence structure is “be+p.p”, the Linking Pointer of the specific sentence elements and the discerning factor check whether the translated Chinese verb of the original English sentence rules over, or exercises influence over the action of the animate/things or not. Next the Linking Pointer of the specific sentence elements and the discerning factor recheck the translated Chinese word of the English preposition—which locates just behind the English verb—whether that translated Chinese word is proper or not, in relation to the translated Chinese verb according to the Chinese grammar. Because the translated Chinese word of the English preposition has some special translation conditions in Chinese grammar.
5) If the original English sentence structure is an adjective phrase sentence, the Linking Pointer of the specific sentence elements and the discerning factor eliminate the translated Chinese word for the original English word “be” and next reconstruct the translated Chinese words according to the word order rules in Chinese grammar.

The recording medium by which this auto translation method is programmed, as mentioned above, consists of:

(1) The Word Database (100): It has 4 corresponding dictionaries db. Every db is arranged in alphabetical order and recorded the whole information of the English words and the translated Chinese words according to the dictionary editing system in English and Chinese language.

(2) The device (200): It analyzes the words of the inputted original sentence into the morpheme units.

(3) The device (300) It arranges the results of (200) for the basic sentence elements that contain a part of speech, and this device translates the original English words into Chinese words according to the word dictionary db.

(4) The device (400)—the modulatory translation module: It checks whether the compound word, idiom, colloquialism exist in the results of (300) or not. And if there are, this device modulates the basic sentence elements of them into the modulatory sentence elements and converts a part of speech of them if it needs to do(In this process, new converted word class being created). And this device translates the original English words into Chinese words according to the word dictionary db.

(5) The device (500)—the specific translation module: It checks the results of (300), the results of (400) and checks the inputted original sentence with the Linking Pointer of the specific sentence elements. And if a linking data exists between them, the Linking Pointer of the specific sentence elements checks whether the data of the word (words) is marked with the discerning factor or not. If it is, the Linking Pointer of the specific sentence elements and the discerning factor indicate that the word (words) should be controlled by the one of 5 (peculiar) specific translation modules. This module (500) has 5 (peculiar) specific translation modules (501˜505) that are activated by the Linking Pointer of the specific sentence elements and the discerning factor jointly. And this device (500) rechecks the results of each specific translation module and rearranges the translated Chinese words and the word order according to the word order rules in Chinese language.

(6) The device (600)—the general translation module: It checks the results of (500) and eliminates the translated Chinese word which is unnecessary in the final translated Chinese sentence and inserts the special Chinese word which is necessary in the final translated Chinese sentence, according to the special translation conditions in Chinese grammar. It rechecks whether the secondly translated Chinese word—which is converted again by the specific translation module—is linked with the word order rules of the Word Database or not. If it is, this device reconstructs the word order of the translated Chinese words according to the word order rules in Chinese language.

(7)The device (700): It outputs the complete translated Chinese sentence.

The Linking Pointer of the specific sentence elements which links with the device (500) cooperates with 5 (peculiar) Specific Translation Modules (501˜505).

The First Specific Translation Module (501) checks, by the Linking Pointer of the specific sentence elements and the discerning factor, whether the translated Chinese verb of the original English sentence belongs to Liheci [symbol] or not. If it belongs to Liheci, this module checks whether the original English sentence is the past tense or not. And the result of checking is the past tense, this module puts [symbol] between the two separated words of the translated Chinese verb. At the same time this module checks whether the original English sentence has an adverb of frequency or not. And if it has, this module puts, by the Linking Pointer of the specific sentence elements and the discerning factor, the translated Chinese word for the adverb of frequency in English just after [symbol] . If the original English sentence is not the past tense, the translated Chinese word for the adverb of frequency in English is located without [symbol] .

The Second Specific Translation Module (502) checks the translated Chinese words, by the Linking Pointer of the specific sentence elements and the discerning factor, whether the word—the complement of degree, as a sentence element—exists or not. If it exists, the Linking Pointer of the specific sentence elements and the discerning factor check whether the complement of degree accompanies the translated Chinese verb of the original English sentence or not. If it does, this module inserts the Chinese word [symbol] just behind the translated Chinese verb. And just after the word [symbol] , this module locates the translated Chinese word, the complement of degree.

The Third Specific Translation Module (503) checks the translated Chinese words, by the Linking Pointer of the specific sentence elements and the discerning factor, whether the word—the complement of result, as a sentence element—exists or not. If it exists, the Linking Pointer of the specific sentence elements and the discerning factor check whether the complement of result accompanies the translated Chinese verb of the original English sentence or not. If it does, this module locates the translated Chinese word, the complement of result, just after the translated Chinese verb.

The Fourth Specific Translation Module (504) checks, by the Linking Pointer of the specific sentence elements and the discerning factor, whether the original English sentence structure is “be+p.p” or not. If it is, this module checks whether the translated Chinese verb of the original English sentence rules over, or exercises influence over the action of the animate/things or not. And if it does, the Chinese word [symbol] is affixed to the head of the translated Chinese verb. Next this module, by the Linking Pointer of the specific sentence elements and the discerning factor, rechecks the translated Chinese word of the English preposition—which locates just behind the English verb—whether that translated Chinese word is proper or not, in relation to the translated Chinese verb according to the Chinese grammar. Because the translated Chinese word of the English preposition has some special translation conditions in Chinese grammar. And next this module reconstructs the translated Chinese words according to the word order rules in Chinese language.

The Fifth Specific Translation Module (505) checks, by the Linking Pointer of the specific sentence elements and the discerning factor, whether the original English sentence is an adjective phrase sentence or not. If it is, this module eliminates the translated Chinese word of the original English word “be” and next reconstructs the translated Chinese words according to the word order rules in Chinese language.

Every English word, in the Word Database, has the data about the morpheme units(a common feature), the basic sentence elements (a common feature),the modulatory sentence elements (an independent feature), the specific sentence elements (an independent feature). Especially the specific sentence elements are marked with the discerning factor in the first, the second, the third word dictionary db.

The discerning factor, checks the information of the specific sentence elements in English words, is activated in the specific translation module by the Linking Pointer of the specific sentence elements.

The discerning factor and the Linking Pointer of the specific sentence elements appoint the English word and the translated Chinese word which has the specific sentence elements to the corresponding first˜fifth specific translation module. And they help 5 Specific Translation Modules (501˜505) to translate the original English sentence into the accurate and natural translated Chinese sentence.

The first word dictionary db of the Word Database stored the information of the common word. The second, the third word dictionary db of the Word Database stored the information of the compound word, idiom, colloquialism. The fourth word dictionary db stored the information of the terminology.

When the original English sentence translates into Chinese sentence,
1) If the translated Chinese verb—which is selected from the Word Database—belongs to Liheci, the Linking Pointer of the specific sentence elements and the discerning factor check whether the original English sentence is the past tense or not, and check whether the original English sentence has an adverb of frequency or not.
2) If the translated Chinese word is checked as the word of the complement of degree, the Linking Pointer of the specific sentence elements and the discerning factor check whether the word itself accompanies the translated Chinese verb of the original English sentence or not.
3) If the translated Chinese word is checked as the word of the complement of result, the Linking Pointer of the specific sentence elements and the discerning factor check whether the word itself accompanies the translated Chinese verb of the original English sentence or not.
4) If the original English sentence structure is “be+p.p”, the Linking Pointer of the specific sentence elements and the discerning factor check whether the translated Chinese verb of the original English sentence rules over, or exercises influence over the action of the animate/things or not. Next the Linking Pointer of the specific sentence elements and the discerning factor recheck the translated Chinese word of the English preposition—which locates just behind the English verb—whether that translated Chinese word is proper or not, in relation to the translated Chinese verb according to the Chinese grammar. Because the translated Chinese word of the English preposition has some special translation conditions in Chinese grammar.
5) If the original English sentence structure is an adjective phrase sentence, the Linking Pointer of the specific sentence elements and the discerning factor eliminate the translated Chinese word of the original English word “be” and next reconstruct the translated Chinese words according to the word order rules in Chinese grammar.

The automatic translation method of this invention consists of
The stage (S100): has the Word Database.
The stage (S200): analyzes the words of the inputted original sentence into the morpheme units.
The stage (S300): arranges the results of (200) for the basic sentence elements that contain a part of speech, and translates the original English words into the translated Chinese words according to the word dictionary db.
The stage (S400): checks whether the compound word, idiom, colloquialism exist in the results of (300) or not. And if there are, this stage modulates the basic sentence elements of them into the modulatory sentence elements and converts a part of speech of them if it needs to do (In this process, new converted word class being created). And this stage translates the original English words into Chinese words according to the word dictionary db.
The stage (S500): checks the results of (300), the results of (400) and checks the inputted original sentence with the Linking Pointer of the specific sentence elements. And if a linking data exists between them, the Linking Pointer of the specific sentence elements checks whether the data of the word (words) is marked with the discerning factor or not. If it is, the Linking Pointer of the specific sentence elements and the discerning factor indicate that the word (words) should be controlled by the one of 5 (peculiar) specific translation modules. And this stage rechecks the results of each specific translation module and rearranges the translated Chinese words and the word order according to the word order rules in Chinese language.
The stage (S600): checks the results of (500) and eliminates the translated Chinese word which is unnecessary in the final translated Chinese sentence and inserts the special Chinese word which is necessary in the final translated Chinese sentence, according to the special translation conditions in Chinese grammar. And this stage rechecks whether the secondly translated Chinese word—which is converted again by the specific translation module—is linked with the word order rules of the Word Database or not. If it is, this stage reconstructs the translated Chinese words according to the word order rules in Chinese language.
The stage (S700): outputs the complete translated Chinese sentence.

In the stage of the device (S500): The Linking Pointer of the specific sentence elements which links with the device (500) and the discerning factor, which is marked to the original English word, check whether the translated Chinese verb of the original English sentence belongs to Liheci [symbol] or not. And if it belongs to Liheci, the translated Chinese verb is controlled by the first specific translation module. The discerning factor and the Linking Pointer of the specific sentence elements, in the first specific translation module, check whether the original English sentence is the past tense or not. The result of checking is the past tense, this module puts [symbol] between the two separated words of the translated Chinese verb. At the same time the Linking Pointer of the specific sentence elements and the discerning factor check whether the original English sentence has an adverb of frequency or not. If it has, the first specific translation module puts the translated Chinese word for the adverb of frequency in English just after [symbol] . If the original English sentence is not the past tense, the translated Chinese word for the adverb of frequency in English is located without [symbol] .

In the stage of the device (S500): If the translated Chinese word is checked as the word of the complement of degree, by the Linking Pointer of the specific sentence elements and the discerning factor, the second specific translation module checks whether the complement of degree accompanies the translated Chinese verb of the original English sentence or not. And if it does, this module inserts the Chinese word [symbol] just behind the translated Chinese verb. And just after the word [symbol] , this module locates the translated Chinese word, the complement of degree. (S502)

In the stage of the device (S500): If the translated Chinese word is checked as the word of the complement of result, by the Linking Pointer of the specific sentence elements and the discerning factor, the third specific translation module checks whether the complement of result accompanies the translated Chinese verb of the original English sentence or not. And if it does, this module locates the translated Chinese word, the complement of result, just after the translated Chinese verb. (S503)

In the stage of the device (S500): If the original English sentence structure is “be+p.p”, the Linking Pointer of the specific sentence elements and the discerning factor check, in the fourth specific translation module, whether the translated Chinese verb of the original English sentence rules over, or exercises influence over the action of the animate/things or not. If it does, the Chinese word [symbol] is affixed to the head of that translated Chinese verb. Next this module rechecks the translated Chinese word of the English preposition—which locates just behind the English verb—whether that translated Chinese word is proper or not, in relation to the translated Chinese verb according to the Chinese grammar. Because the translated Chinese word of the English preposition has some special translation conditions in Chinese grammar. And next it reconstructs the translated Chinese words according to the word order rules in Chinese language. (S504)

In the stage of the device (S500): The Linking Pointer of the specific sentence elements and the discerning factor, in the fifth specific translation module, check whether the original English sentence is an adjective phrase sentence or not. And if it is, this module eliminate the translated Chinese word of the original English word “be” and this module reconstructs the translated Chinese words according to the word order rules in Chinese language. (S505)

In the stage of the device (S500), the Linking Pointer of the specific sentence elements and the discerning factor and each specific translation module work as trinity.

### BRIEF DESCRIPTION OF DRAWINGS

Here are the detailed explanations which referring to the attached figures for the sample sentences of real translation through the operation of this auto (machine) translator(Demo Program, developed in 2003 3).

FIG. 1: the system composition of this auto translator from this invention.

FIG. 2: the block diagram for the device of the specific translation modules, as the constituent units in this auto translator.

FIG. 3: the flow-chart that shows the process of translation in this auto translator.

FIG. 4: shows the function of 5 specific translation nodues (501˜505).

FIG. 5: the first example of operation from this invention that shows the process of translation for Liheci verb structure. FIG. 5˜FIG. 9 were quoted from the results of Demo Program in this invention by the applicant.

FIG. 6: the second example of operation from this invention that shows the process of translation for the complement of degree syntax structure.

FIG. 7: the third example of operation from this invention that shows the process of translation for the complement of result syntax structure.

FIG. 8: the fourth example of operation from this invention that shows the process of translation for the passive voice syntax structure.

FIG. 9: the fifth example of operation from this invention that shows the process of translation for the adjective phrase sentence syntax structure.

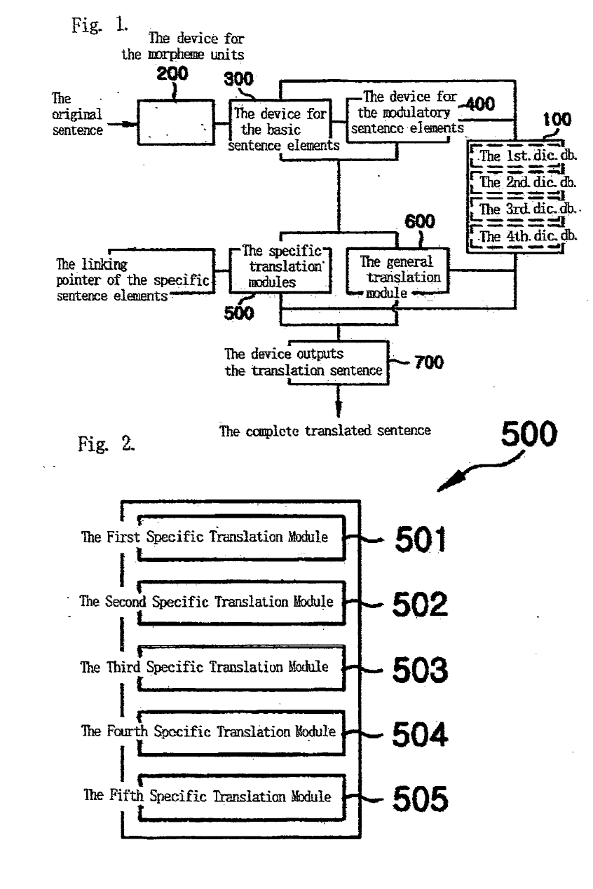

### BEST MODE FOR CARRYING OUT THE INVENTION

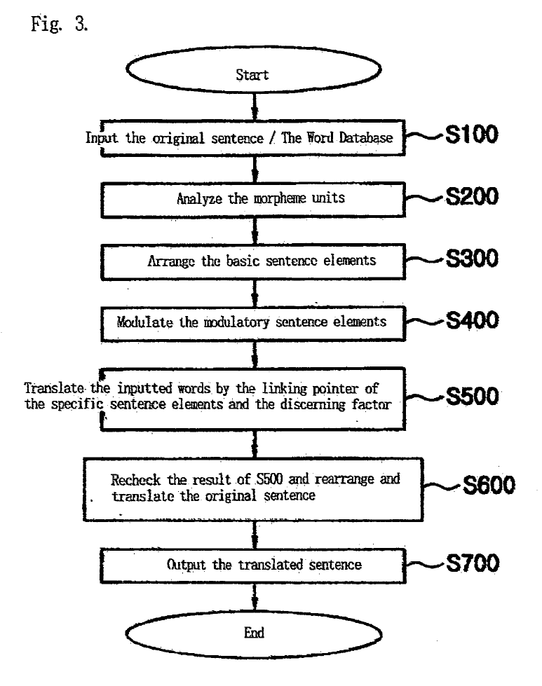

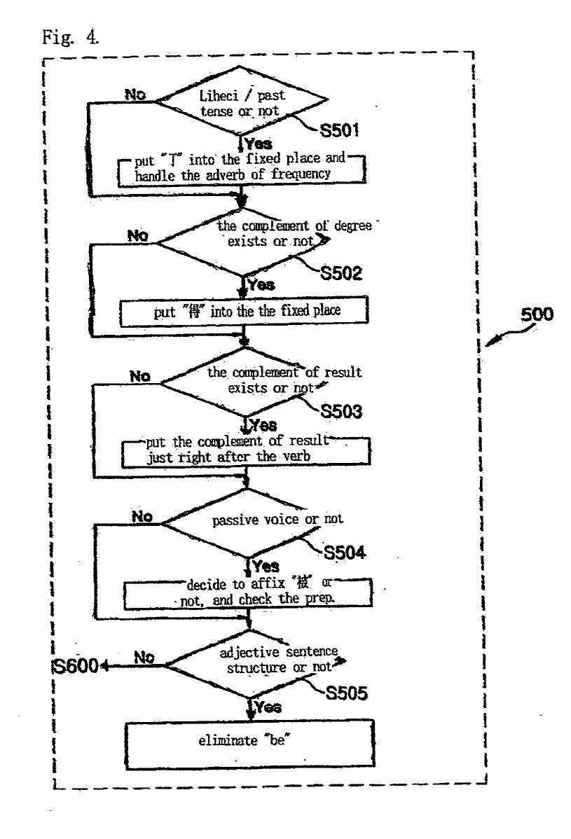

Now let's observe the operation of the auto translator from this invention. When the user inputs the original English sentence, “I have not chatted with him once.” (cf. FIG. 5), this sentence appears in the input space of the active window for translation.(cf. FIG. 3/S100) After the user inputs this English sentence and clicks the translation menu in the active window, the auto translator will show the translated Chinese sentence immediately. Let's observe the process of translation from this auto translator.

First of all, the analyzing morpheme units device (200) analyzes every word of the inputted original English sentence into the morpheme units. The arranging basic sentence elements device (300) gradually matches every morpheme unit of the original English sentence with the word dictionary db in the Word Database. And synchronously this device arranges and defines them as a pronoun, noun, verb, negative, auxiliary, adjective, preposition, adverb, article, conjunction, relative, 10 narration, participle, gerund, numerals, etc. (S300)

The adjusting modulatory sentence elements device (400) firstly checks whether the compound word, idiom, colloquialism exist in the results of (300) or not. If there are, this device modulates the basic sentence elements of them into the modulatory sentence elements and next this device matches them with the word dictionary db in the Word Database. Synchronously this device (400) converts and adjusts a part of speech of them, if it needs to do. In this process—new converted word class being created—the features of tense, subject, phrasal verb, prepositional phrase, noun phrase, adverbial phrase in the inputted original sentence are adjusted and defined newly. (S400)

Next the device (500)—the specific translation module—with the Linking Pointer of the specific sentence elements checks the results of the device (400) whether the discerning factor exists or not in the inputted original English word. The discerning factor, which is activated by the Linking Pointer of the specific sentence elements, checks the features of the modulatory sentence elements of the original English word and rearranges the modulatory sentence elements for the specific sentence elements, if it needs to do. And then the discerning factor and the Linking Pointer of the specific sentence elements indicate that the word (words), which has the specific sentence element, should be controlled by the one of 5 peculiar specific translation modules. This process reveals the functional meaning of every specific sentence element of the original English words. This process translates the original English words into the accurate, natural translated Chinese sentence.

The inputted original English sentence, “I have not chatted with him once.” passes through the device (200), (300), (400), and the dictionary db, then the related data reach the device (500).

During the process of (200), (300), (400), the word in the original English sentence “I” is translated into the Chinese word [symbol] , the words “have” and “not” are translated into the Chinese word [symbol] and [symbol] , and the word “chatted” is translated into the Chinese word [symbol] , and “with” is translated into the Chinese word [symbol] and “him” is translated into the Chinese word [symbol] , and “once” is translated into the Chinese word [symbol] .

The Linking Pointer of the specific sentence elements checks the related whole data of the original English sentence and finds that the verb “chatted” is marked with the discerning factor of Liheci [symbol] . This discerning factor and the Linking Pointer of the specific sentence elements decide that the next process of this word should be executed in the first specific translation module (501). The first specific translation module examines the verb “chatted” in reference to the word data and finds that the verb “chatted” is the past tense verb. Synchronously the Lining Pointer of the specific sentence elements and the discerning factor, in the first specific translation module, examine the verb “chatted” in the dictionary db and find that the accurate and natural translated Chinese verb is not [symbol] but, Liheci, [symbol] .

Next the Linking Pointer of the specific sentence elements and the discerning factor insert [symbol] (This Chinese letter means that the sentence is the past tense.) between the Liheci, [symbol] .

Then the translated Chinese verb forms [symbol] .

After this process, the Linking Pointer of the specific sentence elements and the discerning factor, in the first specific translation module, recognize that the original English sentence has the adverb of frequency “once”. The Linking Pointer of the specific sentence elements and the discerning factor examine the dictionary db and find that the translated Chinese adverb of frequency is [symbol] . Next this module inserts the word [symbol] between the [symbol] . Then the translation Chinese verb and the translated Chinese adverb form [symbol] . The first specific translation module translates the words “chatted” and “once” in the original English sentence into the translated Chinese words [symbol] .

The result is very accurate and natural in Chinese language.

The Linking Pointer of the specific sentence elements and the discerning factor in the first specific translation module of this auto translator are programmed to check whether the translated Chinese verb word of the original English sentence belongs to Liheci or not. And to check whether the original English sentence has an adverb of frequency or not.

When the Linking Pointer of the specific sentence elements does not find the word which is marked with the discerning factor, the specific translation module (500) finishes the translation process of the specific sentence elements for the original English sentence.

After this process, the inputted original English sentence, “I have not chatted with him once.” Is translated into [symbol] [symbol] . The general translation module (600) receives and checks the results of (500) and eliminates the translated Chinese word which is unnecessary in the final translated Chinese sentence and inserts the special Chinese word which is necessary in the final translated Chinese sentence, according to the special translation conditions in Chinese grammar. Next this module checks whether each result of (500) is linked with the word order rules in the Word Database or not. And if it is, this module reconstructs the translated Chinese words according to the word order rules in Chinese language.

At this process, the translated Chinese word [symbol] is eliminated in the final translated Chinese sentence. And the words in the original English sentence “with him”, the translated Chinese words [symbol] are located right after the Chinese word [symbol] according to the word order rules in Chinese language.

The process of the general translation module (600) builds the final translated Chinese sentence, [symbol] [symbol] (S600)

Finally the device (700) outputs the complete translated Chinese sentence. Output space of the auto translator in the computer screen shows [symbol] [symbol] .

This is an accurate and natural Chinese sentence. And this technological algorithm does not exist until now.

The successive process from the inputting original English sentence to the process in the device of modulatory translation module (S100˜S400) is all the same.

So the following explanations are about how the device (500)—the specific translation module—operates and controls the specific sentence elements of the original English words and the process of the 5 specific translation modules (501˜505), as comparing with 5 Figures. (cf. FIG. 5, 6, 7, 8, 9.)

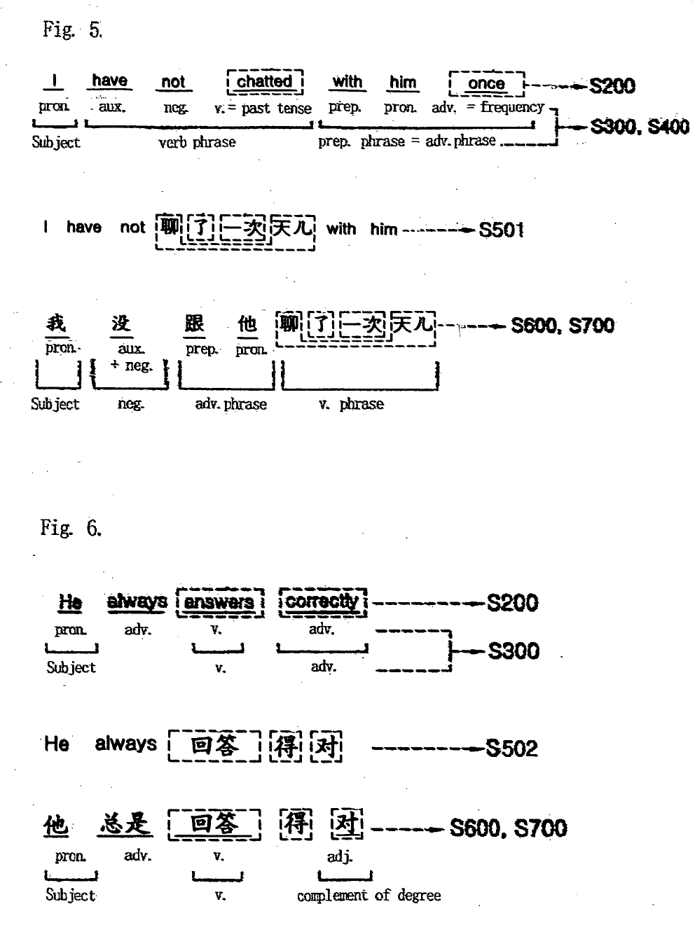

The inputted original English sentence, “He always answers correctly.” (cf. FIG. 6), was analyzed, arranged and modulated through the process of the device (200), (300),(400) and matched with the translated Chinese words through the corresponding word dictionary db. “He” corresponds to [symbol] and “always” corresponds to [symbol] and “answers” corresponds to [symbol] and “correctly” corresponds to [symbol] .

When the results of the device (400) is conveyed to the device (500), the Linking Pointer of the specific sentence elements checks every word in the original English sentence and the translated Chinese words—“He always answers correctly.”/ [symbol] [symbol] .

In this process, every word is checked whether the discerning factor is marked or not. When this process finds that the word “correctly” is marked with the discerning factor, the Linking Pointer of the specific sentence elements activates this discerning factor of the word “correctly”. This discerning factor and the Linking Pointer of the specific sentence elements begin to check the features of the word “correctly” with the word dictionary db.

They find that the translated Chinese word for the English word “correctly” should be treated as the complement of degree in Chinese grammar.

And now the discerning factor of the word “correctly” and the Linking Pointer of the specific sentence elements notify that this original English word must be handled by the second specific translation module (502). They decide that the firstly corresponding translated Chinese word [symbol] is not correct according to Chinese grammar. The discerning factor and the Linking Pointer of the specific sentence elements, in the second specific translation module, recheck the word “correctly” with the word dictionary db and find that the accurate and natural Chinese word is not [symbol] but [symbol] .

The second specific translation module with the Linking Pointer of the specific sentence elements and the discerning factor check whether the word [symbol] which is the secondly translated Chinese word, accompanies the translated Chinese verb [symbol] of the original English verb “answers” or not. The result is affirmative, the Linking Pointer of the specific sentence elements and the discerning factor, in the second specific translation module, insert the special Chinese word [symbol] just behind the translated Chinese verb [symbol] and just after the word [symbol] locates the secondly translated Chinese word [symbol] as the complement of degree in Chinese language.

Now the device (500) checks the word order rules in Chinese language and translates the original English sentence, “He always answers correctly.” into the translated Chinese sentence,

[symbol]

The general translation module (600) receives and checks the result of the device (500) and finds no clue to rearrange the result.

Now this module builds the final translated Chinese sentence, [symbol] [symbol] (S600)

Finally the device (700) outputs the complete translated Chinese sentence. Output space of the auto translator in the computer screen shows [symbol] [symbol] (S700)

This is an accurate and natural Chinese sentence. And this technological algorithm does not exist until now.

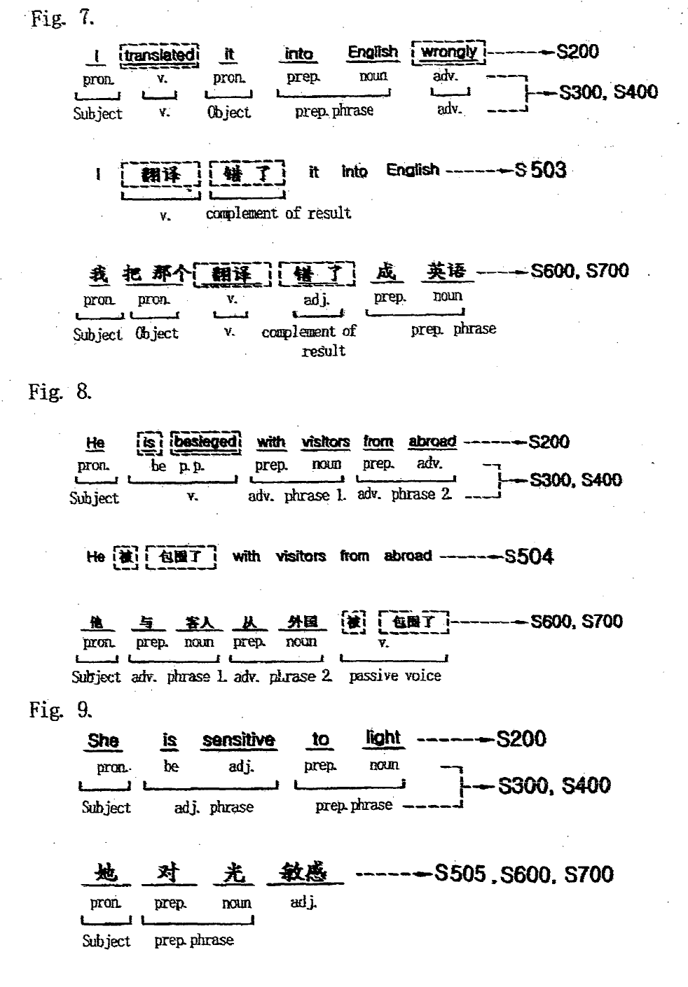

The inputted original English sentence, “I translated it into English wrongly.” (cf. FIG. 7), was analyzed, arranged and modulated through the process of the device (200), (300), (400) and matched with the translated Chinese words through the word dictionary db.

“I” corresponds to [symbol] and “translated” corresponds to [symbol] and “it” corresponds to [symbol] and “into” corresponds to [symbol] and “English” corresponds to [symbol] and “wrongly” corresponds to [symbol] .

When the results of the device (400) is conveyed to the device (500), the Linking Pointer of the specific sentence elements checks every word in the original English sentence and the translated Chinese words—I translated it into English wrongly. / [symbol] [symbol] .

In this process, every word is checked whether the discerning factor is marked or not by the Linking Pointer of the specific sentence elements. When it finds that the word “wrongly” is marked with the discerning factor, the Linking Pointer of the specific sentence elements activates this discerning factor of the word “wrongly”. This discerning factor and the Linking Pointer of the specific sentence elements begin to check the features of the word “wrongly” with the word dictionary db. They find that the translated Chinese word for the English word “wrongly” should be treated as the complement of result in Chinese language.

And now the discerning factor of the word “wrongly” and the Linking Pointer of the specific sentence elements notify that this original English word must be handled by the third specific translation module (503). They decide that the firstly translated Chinese word [symbol] is not correct according to Chinese grammar. They, in the third specific translation module, recheck the word “correctly” with the word dictionary db and find that the accurate and natural Chinese word is not [symbol] but [symbol] .

The third specific translation module with the Linking Pointer of the specific sentence elements and the discerning factor recheck whether the word [symbol] which is the secondly translated Chinese word, accompanies the translated Chinese verb [symbol] for the original English verb “translated” as the complement of result or not. The result is affirmative, the third specific translation module inserts the translated Chinese word [symbol] right after the Chinese verb [symbol] according to the word order rules in Chinese language.

The process of general translation module (600) which receives the results of (500) and checks the translated Chinese sentence which needs to eliminate or insert the special Chinese word, according to the special translation conditions in Chinese grannnar. Next this module rechecks whether every translated Chinese word is linked with the word order rules of the dictionary db or not. If it is, this module reconstructs the word order of the translated Chinese words according to the word order rules in Chinese language.

This time the device of general translation module checks the results of (500) and decides that the Chinese word [symbol] should be inserted in front of the word [symbol] and the word [symbol] should be located right before the Chinese verb [symbol] according to the word order rules in Chinese language.

This module (600) builds the final translated Chinese sentence, [symbol] [symbol] (S600)

Finally the device (700) outputs the complete translated Chinese sentence. Output space of the auto translator in the computer screen shows, [symbol] [symbol] (S700)

This is an accurate and natural Chinese sentence. And this technological algorithm does not exst until now.

The inputted original English sentence, “He is besieged with visitors from abroad.” (cf. FIG. 8), was analyzed, arranged and modulated through the process of the device (200), (300), (400) and matched with the translated Chinese words through the word dictionary db.

“He” corresponds to [symbol] and “is” corresponds to [symbol] and “besieged” corresponds to [symbol] and “with” corresponds to [symbol] and “visitors” corresponds to [symbol] and “from” corresponds to [symbol] and “abroad” corresponds to [symbol] .

When the results of the device (400) is conveyed to the device (500), the Linking Pointer of the specific sentence elements checks every word in the original English sentence and the translated Chinese word—He is besieged with visitors from abroad. / [symbol] [symbol] .

In this process, every word is checked whether the discerning factor is marked or not. When it finds that the original English sentence is the structure of passive voice, “be+p.p”, and is marked with the discerning factor of passive voice. This discerning factor and the Linking Pointer of the specific sentence elements begin to check the features of the original English sentence with the word dictionary db.

Now this discerning factor and the Linking Pointer of the specific sentence elements notify that this original English sentence must be handled by the fourth specific translation module (504). They, in the fourth specific translation module, search the words data, “is besieged”, and check whether the translated Chinese verb [symbol] —of the original English sentence—rules over, or exercises influence over the action of the aninate/things or not. The result is affirmative. They decide that the Chinese word [symbol] should be affixed to the head of the translated Chinese verb. This module converts the firstly translated Chinese phrasal verb, [symbol] into

[symbol]

The discerning factor and the Linking Pointer of the specific sentence elements should recheck the translated Chinese word of the English preposition—which locates just behind the English verb—whether that Chinese word is proper or not, in relation to the translated Chinese verb according to the Chinese grammar.

Thus this discerning factor and the Linking Pointer of the specific sentence elements recheck whether the translated Chinese word [symbol] —the translated Chinese word of the English preposition “with” and which is the firstly translated Chinese word—is proper or not, in relation to the translated Chinese verb, [symbol] according to the Chinese grammar. Because the translated Chinese word of the English preposition has some special translation conditions in Chinese grammar. And the result is negative, they decide that the correct and natural translated Chinese word is not [symbol] but [symbol] according to the special translation conditions in Chinese language grammar.

Next they, in the fourth specific translation module, determine that the prepositional phrase [symbol] corresponds to “with visitors”, should be located right before the translated Chinese phrasal verb [symbol] according to the word order rules in Chinese language. The fourth specific translation module rebuilds the translated Chinese sentence,

[symbol]

[symbol]

The general translation module (600), which receives and checks the results of (500), eliminates the translated Chinese word, [symbol] which corresponds to “is”. Because the translated Chinese word of the English word “is” is unnecessary in the final translated Chinese sentence. And this module rechecks whether every translated Chinese word is linked with the word order rules of the word dictionary db or not. And the result is this: the prepositional phrase [symbol] corresponds to “from abroad”, is linked with the word order rules of the word dictionary db. So this module reconstructs the word order like this: The prepositional phrase, [symbol] corresponds to “from abroad”, should be located just after

[symbol]

This module builds the final translated Chinese sentence, [symbol] [symbol] (S600)

Finally the device (700) outputs the complete translated Chinese sentence. Output space of the auto translator in the computer screen shows [symbol] [symbol] (S700)

This is an accurate and natural Chinese sentence. And this technological algorithm does not exist until now.

The inputted original English sentence, “He is sensitive to light.” (cf. FIG. 9), was analyzed, arranged and modulated through the process of the device (200), (300), (400) and matched with the translated Chinese words through the word dictionary db of the Word Database.

“He” corresponds to [symbol] and “is” corresponds to [symbol] and “sensitive” corresponds to [symbol] and “to” corresponds to [symbol] and “light” corresponds to

[symbol]

Now the Linking Pointer of specific sentence elements checks every word in the original English sentence and the translated Chinese words—He is sensitive to light. /

[symbol]

In this process, every word is checked whether the discerning factor is marked or not. When the Linking Pointer of the specific sentence elements finds the words that are marked with the discerning factor, it activates this factor.

The Linking Pointer of the specific sentence elements and the discerning factor (of the words “is sensitive”) acknowledge this sentence structure as “be+adjective”. The discerning factor of this words and the Linking Pointer of the specific sentence elements notify that this original English sentence must be handled by the fifth specific translation module (505).

The discerning factor of this words and the Linking Pointer of the specific sentence elements, in the fifth specific translation module, find the word data, “is sensitive”, and this module eliminates the translated Chinese word for the original English word “be” and next reconstructs the translated Chinese sentence according to the word order rules in Chinese language.

Now the original English sentence, “He is sensitive to light.” is translated into the Chinese sentence,

[symbol]

Next the process of general translation module (600), which receives and checks the results of (500), decides that the process of elimination for the word which is unnecessary in the final translated Chinese sentence and the process of insertion for the special Chinese word which is necessary in the final translated Chinese sentence, according to the special conditions in Chinese grammar, are no need Then this module rechecks whether the translated Chinese word is linked with the word order rules of the Word Database or not. The result is this: the translated Chinese prepositional phrase [symbol] —corresponds to “to light”—should be located just before the translated Chinese adjective [symbol] —corresponds to “sensitive”—according to the word order rules in Chinese language. So this module reconstructs the word order and builds the final translated Chinese sentence [symbol] (S600)

Finally the device (700) outputs the complete translated Chinese sentence. Output space of the auto translator in the computer screen shows [symbol] (S700).

This is an accurate and natural Chinese sentence. And this technological algorithm does not exist until now. This invention, which explained above in detail, can be changed and transformed within the concept and the sphere of this invention. Such alteration and transformation will belong to the applicant's claims in the sphere of the patent.

1-5. (canceled)

6. An English-Chinese auto translator comprising the devices of: (i) the Word Database 100; (ii) the device 200 analyzing the words of the inputted original sentence into the morpheme units; (iii) the device 300 arranging the results of the device 200 for the basic sentence elements that contain a part of speech; (iv) the device 400 (the modulatory translation module) (a) checking whether the compound word, idiom, colloquialism exist in the results of the device 300 or not, (b) modulating the basic sentence elements of them into the modulatory sentence elements if there are, and (c) converting a part of speech of them if it is needed (in this process, new converted word class being created); (v) the device 500 (the specific translation module) (a) checking the results of the device 300 and the device 400, (b) checking the inputted original sentence with the Linking Pointer of the specific sentence elements, wherein if a linking data exists between them, the Linking Pointer of the specific sentence elements checks whether the data of the word (words) is marked with the discerning factor or not, and if it is, the Linking Pointer of the specific sentence elements and the discerning factor indicate that the word (words) should be controlled by the one of 5 (peculiar) specific translation modules, (c) rechecking the results of each (peculiar) specific translation module, and (d) rearranging the translated Chinese words and the word order according to the word order rules in Chinese language, wherein the device 500 has 5 (peculiar) specific translation modules 501˜505 that are activated by the Linking Pointer of the specific sentence elements and the discerning factor jointly; (vi) the device 600 (the general translation module) (a) checking the results of the device 500, (b) eliminating the translated Chinese word which is unnecessary in the final translated Chinese sentence and inserting special Chinese word which is necessary in the final translated Chinese sentence according to the special translation conditions in Chinese grammar, (c) rechecking whether the secondly translated Chinese word—which is converted again by the specific translation module—is linked with the word order rules of the Word Database or not, wherein if it exists, this device reconstructs the translated Chinese words according to the word order rules in Chinese language, and (d) building the final translated Chinese sentence, and; (vii) the device (700) outputting the complete translated Chinese sentence, wherein the Linking Pointer of the specific sentence elements which links with the device 500 (the specific translation module ) of the English—Chinese auto translator cooperates with 5 (peculiar) Specific Translation Modules 501˜505 having the characteristics of: (i) the First Specific Translation Module 501 checking, by the Linking Pointer of the specific sentence elements and the discerning factor, whether the translated Chinese verb of the original English sentence belongs to Liheci [symbol] or not, wherein if it belongs to Liheci, this module checks, by the Linking Pointer of the specific sentence elements and the discerning factor, whether the original English sentence is the past tense or not, and if the result is affirmative, this module puts [symbol] between the disyllabic or trisyllabic (it is also separated into two parts) word of the translated Chinese verb, at the same time, this module checks, by the Linking Pointer of the specific sentence elements and the discerning factor, whether the original English sentence has an adverb of frequency or not, and if it has, this module puts, by the Linking Pointer of the specific sentence elements and the discerning factor, the translated Chinese word for the English adverb of frequency just after [symbol] and if the original English sentence is not the past tense, the translated Chinese word for the English adverb of frequency is located without [symbol] (ii) the Second Specific Translation Module 502 checking the translated Chinese words, by the Linking Pointer of the specific sentence elements and the discerning factor, whether the word—the complement of degree, as a sentence element—exists or not, wherein if it exists, the Linking Pointer of the specific sentence elements and the discerning factor check whether the complement of degree accompanies the translated Chinese verb of the original English sentence or not, and if it does, this module inserts the Chinese word [symbol] (Chinese letter which expresses the degree of the verb in Chinese sentence) just behind the translated Chinese verb, and just after the word [symbol] this module locates the translated Chinese word, the complement of degree, (iii) the Third Specific Translation Module 503 checking the translated Chinese words, by the Linking Pointer of the specific sentence elements and the discerning factor, whether the word—the complement of result, as a sentence element—exists or not, wherein if it exists, the Linking Pointer of the specific sentence elements and the discerning factor check whether the complement of result accompanies the translated Chinese verb of the original English sentence or not. and if it does, this module locates the translated Chinese word, the complement of result just after the translated Chinese verb, (iv) the Fourth Specific Translation Module 504 checking, by the Linking Pointer of the specific sentence elements and the discerning factor, whether the original English sentence structure is “be+p.p” or not, wherein if it is, this module checks, by the Linking Pointer of the specific sentence elements and the discerning factor, whether the translated Chinese verb of the original English sentence rules over or exercises influence over the action of the animate/things or not, and if it does, the Chinese word [symbol] is affixed to the head of that translated Chinese verb, and then this module with the Linking Pointer of the specific sentence elements and the discerning factor rechecks the translated Chinese word of the English preposition—which locates just behind the English verb—whether that translated Chinese word is proper or not, in relation to the translated Chinese verb according to the Chinese grammar because that translated Chinese word of the English preposition has some special translation conditions in Chinese grammar, and then this module reconstructs the translated Chinese words according to the word order rules in Chinese language, and (v) the Fifth Specific Translation Module 505 checking, by the Linking Pointer of the specific sentence elements and the discerning factor, whether the original English sentence is an adjective phrase sentence or not, wherein if it is, this module eliminates, by the Linking Pointer of the specific sentence elements and the discerning factor, the translated Chinese word for the original English word “be” and then reconstructs the translated Chinese words according to the word order rules in Chinese language.

7. The English-Chinese auto translator according to claim 1, wherein said English—Chinese auto translator comprises the processes of: (i) through the Word Database 100, every translated Chinese word and every word of the original English sentence are checked by the Linking Pointer of the specific sentence elements, which links with the device 500,; (ii) the process of the first specific translation module 501: through the Word Database 100, the Linking Pointer of the specific sentence elements checks every translated Chinese verb and every verb of the original English sentence whether the discerning factor of Liheci [symbol] is marked or not, and if it is, the Linking Pointer of the specific sentence elements and that discerning factor of Liheci check whether the original English sentence is the past tense or not, at the same time, they check whether the original English sentence has an adverb of frequency or not; (iii) the process of the second specific translation module 502: through the Word Database 100, the Linking Pointer of the specific sentence elements checks every translated Chinese word and every inputted original English word whether the discerning factor of the complement of degree is marked or not, and if it is, the Linking Pointer of the specific sentence elements and that discerning factor check whether that translated Chinese word (the complement of degree) accompanies the translated Chinese verb of the original English sentence or not; (iv) the process of the third specific translation module 503: through the Word Database 100, the Linking Pointer of the specific sentence elements checks every translated Chinese word and every inputted original English word whether the discerning factor of the complement of result is marked or not, and if it is, the Linking Pointer of the specific sentence elements and that discerning factor check whether that translated Chinese word (the complement of result) accompanies the translated Chinese verb of the original English sentence or not; (v) the process of the fourth specific translation module 504: through the Word Database 100, the Linking Pointer of the specific sentence elements checks the translated Chinese words and the original English words whether the discerning factor of passive voice is marked or not, and if the result is affirmative, the Linking Pointer of the specific sentence elements and that discerning factor check whether that translated Chinese verb of the original English sentence rules over or exercises influence over the action of the animate/things or not, and they check whether the translated Chinese word of the English preposition—which locates just behind the English verb—is proper or not in Chinese language, and; (vi) the process of the fifth specific translation module 505: through the Word Database 100, the Linking Pointer of the specific sentence elements checks every translated Chinese phrase and every original English phrase whether the discerning factor of “be+adjective” is marked or not, and if it is, the Linking Pointer of the specific sentence elements and that discerning factor eliminate the translated Chinese word for the original English word “be” and then reconstructs the translated Chinese words according to the word order rules in Chinese language, wherein the 4 word dictionaries db in the Word Database 100 is arranged in alphabetical order and recorded the whole information of the English words and the translated Chinese words, especially, the first, the second and the third word dictionary db is recorded the whole information about the word data of the specific sentence elements in English and Chinese words on both sides.

8. A recording medium by which the auto translation method is programmed, comprising the devices of: (i) the Word Database 100; (ii) the device 200 analyzing the words of the inputted original sentence into the morpheme units; (iii) the device 300 (a) arranging the results of the device 200 for the basic sentence elements that contain a part of speech, and (b) translating the original English words into Chinese words according to the word dictionary db; (iv) the device 400 (the modulatory translation module) (a) checking whether the compound word, idiom, colloquialism exist in the results of the device 300 or not, (b) modulating the basic sentence elements of them into the modulatory sentence elements if there are, and (c) converting a part of speech of them if it is needed (in this process, new converted word class being created), wherein this device translates the original English words into Chinese words according to the first, the second and the third dictionary db; (v) the device 500 (the specific translation module) (a) checking the results of the device 300 and the device 400, (b) checking the inputted original sentence with the Linking Pointer of the specific sentence elements, wherein if a linking data exists between them, this device checks whether the data of the word (words) is marked with the discerning factor or not, and if it is, the Linking Pointer of the specific sentence elements and the discerning factor indicate that the word (words) should be controlled by the one of 5 (peculiar) specific translation modules, (c) rechecking the results of each (peculiar) specific translation module, and (d) rearranging the translated Chinese words and word order according to the word dictionary db, wherein the device 500 has 5 (peculiar) specific translation modules 501˜505 that are activated by the Linking Pointer of the specific sentence elements and the discerning factor jointly, and through the process of this device 500, the data of the original English words are translated into the accurate, natural Chinese words according to the Word Database; (vi) the device 600 (the general translation module) (a) checking the results of the device 500, (b) eliminating the translated Chinese word which is unnecessary in the final translated Chinese sentence and inserting the special Chinese word which is necessary in the final translated Chinese sentence according to the special translation conditions in Chinese language grammar, and (c) rechecking whether the secondly translated Chinese word—which is converted again by the specific translation module—is linked with the word order rules of the Word Database or not, wherein if it exists, this module reconstructs the word order of the secondly translated Chinese words according to the word order rules in Chinese language, and; (vii) the device 700 outputting the complete translated Chinese sentence, wherein the Linking Pointer of the specific sentence elements which links with the device 500 (the specific translation module) of the recording medium by which the auto translation method is programmed, cooperates with 5 (peculiar) Specific Translation Modules 501˜505 having the characteristics of: (i) the First Specific Translation Module 501 checking, by the Linking Pointer of the specific sentence elements and the discerning factor, whether the translated Chinese verb of the original English sentence belongs to Liheci [symbol] or not, wherein if it belongs to Liheci, this module checks whether the original English sentence is the past tense or not, and if the result of checking is the past tense, this module puts [symbol] between the two separated words of the translated Chinese verb, and then this module checks whether the original English sentence has an adverb of frequency or not, and if it has, this module puts the translated Chinese word for the adverb of frequency in English just after [symbol] and if the original English sentence is not the past tense, the translated Chinese word for the adverb of frequency in English is located without [symbol] (ii) the Second Specific Translation Module 502 checking the translated Chinese words, by the Linking Pointer of the specific sentence elements and the discerning factor, whether the word—the complement of degree, as a sentence element—exists or not, wherein if it exists, the Linking Pointer of the specific sentence elements and the discerning factor check whether the complement of degree accompanies the translated Chinese verb of the original English sentence or not, and if it does, this module inserts the Chinese word [symbol] just behind the translated Chinese verb, and just after the word [symbol] this module locates the translated Chinese word, the complement of degree; (iii) the Third Specific Translation Module 503 checking the translated Chinese words, by the Linking Pointer of the specific sentence elements and the discerning factor, whether the word—the complement of result, as a sentence element—exists or not, wherein if it exists, the Linking Pointer of the specific sentence elements and the discerning factor check whether the complement of result accompanies the translated Chinese verb of the original English sentence or not, and if it does, this module locates the translated Chinese word, the complement of result just after the translated Chinese verb; (iv) the Fourth Specific Translation Module 504 checking, by the Linking Pointer of the specific sentence elements and the discerning factor, whether the original English sentence structure is “be+p.p” or not, wherein if it is, this module checks whether the translated Chinese verb of the original English sentence rules over or exercises influence over the action of the animate/things or not, and if it does, the Chinese word [symbol] (this word means the passive voice in Chinese) is affixed to the head of that translated Chinese verb, and then this module, by the Linking Pointer of the specific sentence elements and the discerning factor, rechecks the translated Chinese word of the English preposition—which locates just behind the English verb—whether that translated Chinese word is proper or not, in relation to the translated Chinese verb according to the Chinese grammar because the translated Chinese word of the English preposition has some special translation conditions in Chinese grammar, and then this module reconstructs the translated Chinese words according to the word order rules in Chinese language, and; (v) the Fifth Specific Translation Module 505 checking, by the Linking Pointer of the specific sentence elements and the discerning factor, whether the original English sentence is an adjective phrase sentence or not, wherein if it is, this module eliminates the translated Chinese word for the original English word “be” and then reconstructs the translated Chinese words according to the word order rules in Chinese language, wherein (a) the recording medium by which the auto translation method is programmed, works by computer, (b) every English word, in the Word Database, has the data about the morpheme units (a common feature), the basic sentence elements (a common feature), the modulatory sentence elements (an independent feature), the specific sentence elements (an independent feature), especially, the specific sentence elements are marked with the discerning factor in the first, the second, and the third word dictionary db, and the discerning factor, checks the information of the specific sentence elements in English words, is activated in the 5 (peculiar) specific translation modules by the Linking Pointer of the specific sentence elements, (c) the discerning factor and the Linking Pointer of the specific sentence elements appoint the English word (words), which links with them, to the first˜the fifth specific translation module that translates the original English sentence into the accurate and natural translated Chinese sentence, and (d) the first corresponding word dictionary db of the Word Database stores the information of the common word, the second and the third word dictionary db store the information of the compound word, idiom, colloquialism, and the fourth word dictionary db stores the information of the terminology.

9. The recording medium according to claim 3, wherein said recording medium comprises the processes of: (i) through the Word Database 100, every translated Chinese word and every word of the original English sentence are checked by the Linking Pointer of the specific sentence elements, which links with the device 500; (ii) the process of the first specific translation module 501: through the Word Database 100, the Linking Pointer of the specific sentence elements checks every translated Chinese verb and every verb of the original English sentence whether the discerning factor of Liheci [symbol] is marked or not, and if it is, the Linking Pointer of the specific sentence elements and that discerning factor of Liheci check whether the original English sentence is the past tense or not, at the same time, they check whether the original English sentence has an adverb of frequency or not; (iii) the process of the second specific translation module 502: through the Word Database 100, the Linking Pointer of the specific sentence elements checks every translated Chinese word and every inputted original English word whether the discerning factor of the complement of degree is marked or not, and if it is, the Linking Pointer of the specific sentence elements and that discerning factor check whether that translated Chinese word (the complement of degree) accompanies the translated Chinese verb of the original English sentence or not; (iv) the process of the third specific translation module 503: through the Word Database 100, the Linking Pointer of the specific sentence elements checks every translated Chinese word and every inputted English word whether the discerning factor of the complement of result is marked or not, and if it is, the Linking Pointer of the specific sentence elements and that discerning factor check whether that translated Chinese word (the complement of result) accompanies the translated Chinese verb of the original English sentence or not; (v) the process of the fourth specific translation module 504: through the Word Database 100, the Linking Pointer of the specific sentence elements checks the translated Chinese words and the original English words whether the discerning factor of passive voice is marked or not, and if the result is affirmative, the Linking Pointer of the specific sentence elements and that discerning factor check whether that translated Chinese verb of the original English sentence rules over or exercises influence over the action of the animate/things or not, and they check whether the translated Chinese word of the English preposition—which locates just behind the English verb—is proper or not in Chinese language, and; (vi) the process of the fifth specific translation module 505: through the Word Database 100, the Linking Pointer of the specific sentence elements checks every translated Chinese phrase and every original English phrase whether the discerning factor of “be+adjective” is marked or not, and if it is, the Linking Pointer of the specific sentence elements and that discerning factor eliminate the translated Chinese word for the original English word “be” and then reconstructs the translated Chinese words according to the word order rules in Chinese language, wherein the Word Database 100 is arranged in alphabetical order and recorded the whole information of the English words and the translated Chinese words, especially, the first, the second and the third word dictionary db is recorded the whole information about the word data of the specific sentence elements in English and Chinese words on both sides.

10. The automatic translation method comprising the stages of: (i) the stage S100 having the Word Database; (ii) the stage S200 analyzing the words of the inputted original sentence into the morpheme units; (iii) the stage S300 arranging the results of the device 200 for the basic sentence elements that contain a part of speech, and (b) translating the English words into Chinese words according to the word dictionary db; (iv) the stage S400 (a) checking whether the compound word, idiom, colloquialism exist in the results of the device 300 or not, (b) modulating the basic sentence elements of them into the modulatory sentence elements if there are, and (c) converting a part of speech of them if it is needed (in this process, new converted word class being created), wherein this device translates the original English words into Chinese words according to the word dictionary db: (v) the stage S500 (a) checking the results of the device 300 and the device 400, (b) checking the inputted original sentence with the Linking Pointer of the specific sentence elements, wherein if a linking data exists between them, the device 500 checks whether the data of the word (words) is marked with the discerning factor or not, and if it is, the Linking Pointer of the specific sentence elements and the discerning factor indicate that the word (words) should be controlled by the one of 5 (peculiar) specific translation modules, (c) rechecking the results of each (peculiar) specific translation module, and (d) rearranging the translated Chinese words and word order according to the word order rules in Chinese language; (vi) the stage S600 (a) checking the results of the device 500, (b) eliminating the translated Chinese word which is unnecessary in the final translated Chinese sentence and inserting the special Chinese word which is necessary in the final translated Chinese sentence according to the special translation conditions in Chinese grammar, and (c) rechecking whether the secondly translated Chinese word—which is converted again by the specific translation module—is linked with the word order rules of the Word Database or not, wherein if it exists, this stage reconstructs the word order of the secondly translated Chinese words according to the word order rules in Chinese grammar, and; (vii) the stage S700 outputting the complete translated Chinese sentence, wherein the stage S500 (the specific translation module) of the automatic translation method has the characteristics of: (i) the stage S501: the Linking Pointer of the specific sentence elements and the discerning factor check whether the translated Chinese verb of the original English sentence belongs to Liheci [symbol] one kind of verbs in Chinese Grammar—or not, wherein if it belongs to Liheci, the first specific translation module checks whether the original English sentence is the past tense or not, and if the result is the past tense, the first specific translation module puts [symbol] (this Chinese letter means that the sentence is the past tense) between the two separated words of the translated Chinese verb, and then the first specific translation module, by the Linking Pointer of the specific sentence elements and the discerning factor, checks whether the original English sentence has an adverb of frequency or not, and if it has, this module puts the translated Chinese word for the English adverb of frequency just after [symbol] and if the English sentence is not the past tense, the translated Chinese word for the English adverb of frequency is located without [symbol] (ii) the stage (S502): if the translated Chinese word is checked as the word of the complement of degree by the Linking Pointer of the specific sentence elements and the discerning factor, the second specific translation module checks whether the complement of degree accompanies the translated Chinese verb of the original English sentence or not, and if it does, this module inserts the Chinese word [symbol] just behind the translated Chinese verb, and just after the word [symbol] this module locates the translated Chinese word, the complement of degree; (iii) the stage (S503): if the translated Chinese word is checked as the word of the complement of result by the Linking Pointer of the specific sentence elements and the discerning factor, the third specific translation module checks whether the complement of result accompanies the translated Chinese verb of the original English sentence or not, and if it does, this module locates the translated Chinese word, the complement of result, just after the translated Chinese verb; (iv) the stage (S504): the Linking Pointer of the specific sentence elements and the discerning factor check whether the original English sentence structure is “be+p.p” or not, and if it is, the fourth specific translation module checks whether the translated Chinese verb of the original English sentence rules over or exercises influence over the action of the animate/things or not, and if it does, the Chinese word [symbol] (this word means the passive voice in Chinese sentence) is affixed to the head of that translated Chinese verb, and then this module rechecks the translated Chinese word of the English preposition—which locates just behind the English verb—whether that Chinese word is proper or not, in relation to the translated Chinese verb according to the Chinese grammar because the translated Chinese word of the English preposition has some special translation conditions in Chinese grammar, and then this module reconstructs the translated Chinese words according to the word order rules in Chinese language, and; (v) the stage S505: the Linking Pointer of the specific sentence elements and the discerning factor check whether the original English sentence is an adjective phrase sentence or not, and if it is, the fifth specific translation module eliminates the translated Chinese word for the original English word “be” and then reconstructs the translated Chinese words according to the word order rules in Chinese language, wherein the Linking Pointer of the specific sentence elements, the discerning factor and each specific translation module work as trinity in the stage of the device S500.
